(19) United States
(12) Patent Application Publication
(10) Pub. No.: US 2013/0135573 A1
(43) Pub. Date: May 30, 2013

(54) LIQUID CRYSTAL PANEL AND MANUFACTURE METHOD THEREOF

(71) Applicant: Cheng-chaun Chan, Shenzhen (CN)

(72) Inventor: Cheng-chaun Chan, Shenzhen (CN)

(73) Assignee: SHENZHEN CHINA STAR OPTOELECTRONICS TECHNOLOGY CO. LTD., Shenzhen (CN)

(21) Appl. No.: 13/379,053

(22) PCT Filed: Dec. 1, 2011
(86) PCT No.: PCT/CN11/83282

§ 371 Date: Dec. 19, 2011

(30) Foreign Application Priority Data
Nov. 25, 2011 (CN) 201110382322.3

(51) Int. Cl. G02F 1/1339; B32B 37/02

(52) U.S. Cl. 349/153; 156/146

(57) ABSTRACT

Disclosed is a liquid crystal panel, comprising a first substrate, a second substrate and a liquid crystal layer located between the first substrate and the second substrate, and the first substrate and the second substrate comprises a display area and a non display area around the display area, and a main sealant utilized for sealing the liquid crystal layer is disposed in the non display area, and a main spacer, sub spacers and a first ball spacer are positioned in the display area for maintaining a gap between the first substrate and the second substrate. The present invention also relates to a manufacture method of a liquid crystal panel. The liquid crystal panel and the manufacture method thereof of the present invention solve the technical problem of over large edge gap by positioning ball spacers to reinforce the support strength between two substrates.

### BACKGROUND OF THE INVENTION

1. Field of the Invention

The present invention generally relates to a liquid crystal panel manufacture field, and more particularly to a liquid crystal panel and manufacture method thereof providing well support strength.

2. Description of Prior Art

ODF (one drop filling) process is to combine the liquid crystal injection and substrate assembly. Because the liquid crystal is dropped on the substrate directly and the liquid crystal injection port is no longer required, the ODF process helps to complete the manufacture of the liquid crystal panel merely with few processes, the liquid crystal drop, the compression, the solidification and cutting. The manufacture processes is decreased. The product manufacture time is shortened. The manufacture cost is lowered. However, in the ODF process according to prior art, an issue of over large gap at the edge of the liquid crystal panel and the peripheral structure exists. The cause is the liquid crystal panel warpage due to the bad support strength between the two substrates. Generally, reinforcement of the support strength between the two substrates is made to improve the condition of the over large edge gap in the liquid crystal panel.

The support strength between the two substrates is mainly provided by the spacers on the substrate and the sealant for jointing the two substrates. Commonly, the methods described below are utilized for solving the issue of over large gap at the edge of the liquid crystal panel due to the insufficient support strength between the two substrates:

1. The grain size of the material of the sealant can be increased to reinforce the support strength between the two substrates; however, such method increase the usage amount of the sealant and increase the manufacture cost.

2. The seal of the liquid crystal panel can be changed from dose type to open type to diminish the effect of the differential pressure between interior and exterior to the support strength of the liquid crystal panel; however, such method may easily causes the interior pollution of the liquid crystal pan& from exterior and the display quality of the liquid crystal panel is affected.

3. The distribution of the spacers can be changed to reinforce the support strength between the two substrates; however, such method requires new mask or modifies the original mask to change the positions of the spacers because the spacers are generally deposited and formed on the first substrate by using mask. The cost to modify the mask is huge. Accordingly, the manufacture cost of the liquid crystal panel may get large increased.

Consequently, there is a need to provide a liquid crystal panel and a manufacture method thereof to solve the existing problems of prior arts.

### SUMMARY OF THE INVENTION

An objective of the present invention is to provide a liquid crystal panel and a manufacture method thereof to solve the problem of the bad support strength between two substrates according to a liquid crystal panel and a manufacture method of prior art which increases the cost of the liquid crystal panel and causes technical problem of the interior pollution to the liquid crystal panel.

For solving the aforesaid problems, the technical solution provided by the present invention is described hereafter:

The present invention relates to a liquid crystal panel, comprising a first substrate, a second substrate and a liquid crystal layer located between the first substrate and the second substrate, and the first substrate and the second substrate comprises a display area and a non display area around the display area, the display area comprises a transparent area and an opaque area. A main sealant utilized for sealing the liquid crystal layer is disposed in the non display area , and a main spacer, sub spacers and a first ball spacer are positioned in the display area for maintaining a gap between the first substrate and the second substrate.

In the liquid crystal panel of the present invention, a sub sealant is further disposed in the non display area at a periphery of the main sealant.

In the liquid crystal panel of the present invention, a second ball spacer is positioned between the main sealant and the sub sealant.

In the liquid crystal panel of the present invention, the second ball spacer is made of opaque material.

In the liquid crystal panel of the present invention, the main spacer, the sub spacer and the first ball spacer are respectively made of transparent material or opaque material and positioned in the transparent area and the opaque area of the display area correspondingly.

The present invention also relates to a liquid crystal panel, comprising a first substrate, a second substrate and a liquid crystal layer located between the first substrate and the second substrate, and the first substrate and the second substrate comprises a display area and a non display area around the display area, and a main sealant utilized for sealing the liquid crystal layer is disposed in the non display area, wherein a main spacer is positioned in the display area for maintaining a gap of between the first substrate and the second substrate. A first ball spacer is further positioned on the first substrate.

In the liquid crystal panel of the present invention, a sub sealant is further disposed in the non display area at a periphery of the main sealant.

In the liquid crystal panel of the present invention, a second ball spacer is positioned between the main sealant and the sub sealant.

In the liquid crystal panel of the present invention, the second ball spacer is made of opaque material.

In the liquid crystal panel of the present invention, the display area comprises a transparent area and an opaque area, and the main spacer and the first ball spacer are made of transparent material, and the main spacer and the first ball spacer are positioned in the transparent area.

In the liquid crystal panel of the present invention, the display area comprises a transparent area and an opaque area, and the main spacer and the first ball spacer are made of opaque material, and the main spacer and the first ball spacer are positioned in the opaque area.

In the liquid crystal panel of the present invention, the display area comprises a transparent area and an opaque area, and the main spacer is made of transparent material and the first ball spacer is made of opaque material, and the main spacer is positioned in the transparent area and the first ball spacer is positioned in the opaque area.

In the liquid crystal panel of the present invention, the display area comprises a transparent area and an opaque area, and the main spacer is made of opaque material and the first ball spacer is made of transparent material, and the main spacer is positioned in the opaque area and the first ball spacer is positioned in the transparent area.

In the liquid crystal panel of the present invention, sub spacers are further positioned in the display area.

The present invention also relates to a manufacture method of a liquid crystal panel, and the liquid crystal panel comprises a first substrate, a second substrate, and the first substrate and the second substrate comprises a display area and a non display area around the display area, the manufacture method of the liquid crystal panel comprising: A, forming a main spacer on the display area of the first substrate; B, positioning a first ball spacer on the first substrate; C, proceeding processes of disposing sealants, dropping liquid crystal and jointing the first substrate and the second substrate sequentially.

In the manufacture method of the liquid crystal panel according to the present invention, the process of disposing sealants is to dispose a main sealant and a sub sealant in the non display area.

In the manufacture method of the liquid crystal panel according to the present invention, the step B further comprises a step of positioning a second ball spacer between the main sealant and the sub sealant by utilizing an inkjet method.

In the manufacture method of the liquid crystal panel according to the present invention, the step A further comprises a step of positioning sub spacers in the display area.

In the manufacture method of the liquid crystal panel according to the present invention, the step B is to position the first ball spacer in the display area on the first substrate by utilizing an inkjet method.

With implementing the liquid crystal panel and the manufacture method of the present invention, following benefit is possible to be gained: By positioning ball spacers to reinforce support strength between two substrates, the technical problem of over large edge gap due to a liquid crystal panel and a manufacture method of prior art can be solved.

For a better understanding of the aforementioned content of the present invention, preferable embodiments are illustrated in accordance with the attached figures for further explanation:

### BRIEF DESCRIPTION OF THE DRAWINGS

FIG. 1 depicts a structure diagram of a liquid crystal panel according to a first preferable embodiment of the present invention;

FIG. 2 depicts a structure diagram of a liquid crystal panel according to a second preferable embodiment of the present invention;

FIG. 3 depicts a structure diagram of a liquid crystal panel according to a third preferable embodiment of the present invention;

FIG. 4 depicts a flowchart of a manufacture method of the liquid crystal panel according to a preferable embodiment of the present invention .

### DETAILED DESCRIPTION OF THE INVENTION

The following descriptions for the respective embodiments are specific embodiments capable of being implemented for illustrations of the present invention with referring to appended figures.

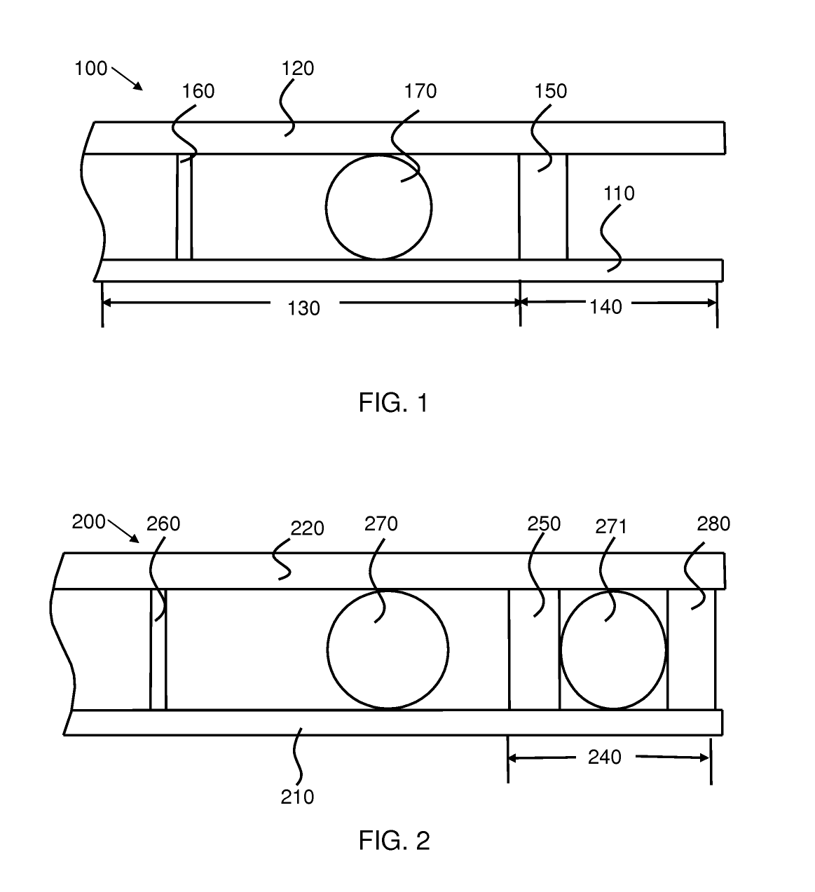

Please refer to FIG. 1, which depicts a structure diagram of a liquid crystal panel according to a first preferable embodiment of the present invention. The liquid crystal panel 100 comprises a first substrate 110, a second substrate 120 and a liquid crystal layer (not shown) located between the first substrate 110 and the second substrate 120. The first substrate 110 and the second substrate 120 comprise a display area 130 and a non display area 140 around the display area 130. A main sealant 150 utilized for sealing the liquid crystal layer is disposed in the non display area 140. A main spacer 160 and a first ball spacer 170 injected by an inkjet method are positioned in the display area 130 for maintaining a gap between the first substrate 110 and the second substrate 120. Both the main spacer 160 and the first ball spacer 170 are positioned on the first substrate 110. In this embodiment, the first substrate 110 is a color filter substrate and the second substrate 120 is a thin film transistor substrate; alternatively, the first substrate 110 is a thin film transistor substrate and the second substrate 120 is a color filter substrate. Specifically, in some embodiment, the color filter and the thin film transistor array can be positioned on the same substrate.

With positioning the main spacer 160 and the first ball spacer 170 in the display area 130 of the liquid crystal panel of the present invention at the same time, the support strength between the first substrate 110 and the second substrate 120 is tremendously reinforced. In the present invention, the support strength between the two substrates is reinforced by positioning the first ball spacer 170. The process is simple and the cost is low. Meanwhile, there is no effect to the main spacer 160 which has already been formed.

Preferably, the first ball spacer 170 can be injected by inkjet method. Other method for positioning the first ball spacer 170 also can be employed for certain.

In the liquid crystal panel according to the first embodiment of the present invention, the display area 130 comprises a transparent area and an opaque area. The light can pass through the transparent area but can not pass through the opaque area. As the main spacer 160 is made of opaque material, the main spacer 160 is positioned in the opaque area. As the main spacer 160 is made of transparent material, the main spacer 160 is allowed to be positioned anywhere in the display area; similarly, as the first ball spacer 170 is made of opaque material, the first ball spacer 170 is positioned in the opaque area. As the first ball spacer 170 is made of transparent material, the first ball spacer 170 is allowed to be positioned anywhere in the display area.

FIG. 2, depicts a structure diagram of a liquid crystal panel according to a second preferable embodiment of the present invention. The liquid crystal panel 200 of this embodiment has similar structure as the liquid crystal panel 100 of the first embodiment. The difference is that: the liquid crystal panel 200 of this embodiment further comprises a sub sealant 280 positioned in the non display area 240. The sub sealant 280 is at a periphery of the main sealant 250. A second ball spacer 271 is positioned between the main sealant 250 and the sub sealant 280. In this embodiment, the second ball spacer 271 positioned between the main sealant 250 and the sub sealant 280 is capable of reinforcing the support strength between the first substrate 210 and the second substrate 220 in advance. Because the main spacer 260, the first ball spacer 270 and the second ball spacer 271 are positioned between the first substrate 210 and the second substrate 220, no matter the liquid crystal panel 200 is pressed in any place, either of the main spacer 260, the first ball spacer 270 and the second ball spacer 271 which is compressed and deformed corresponding to the pressure is capable of maintaining the gap between the two substrates to prevent the over large edge gap of the liquid crystal panel 200 due to the bad support strength therebetween.

Same as described in the first embodiment, the main spacer 260 and the first ball spacer 270 can be made of transparent material to be positioned in the transparent area or made of opaque material to be positioned in the opaque area. Selectively, the second ball spacer 271 can be made of transparent material or opaque material.

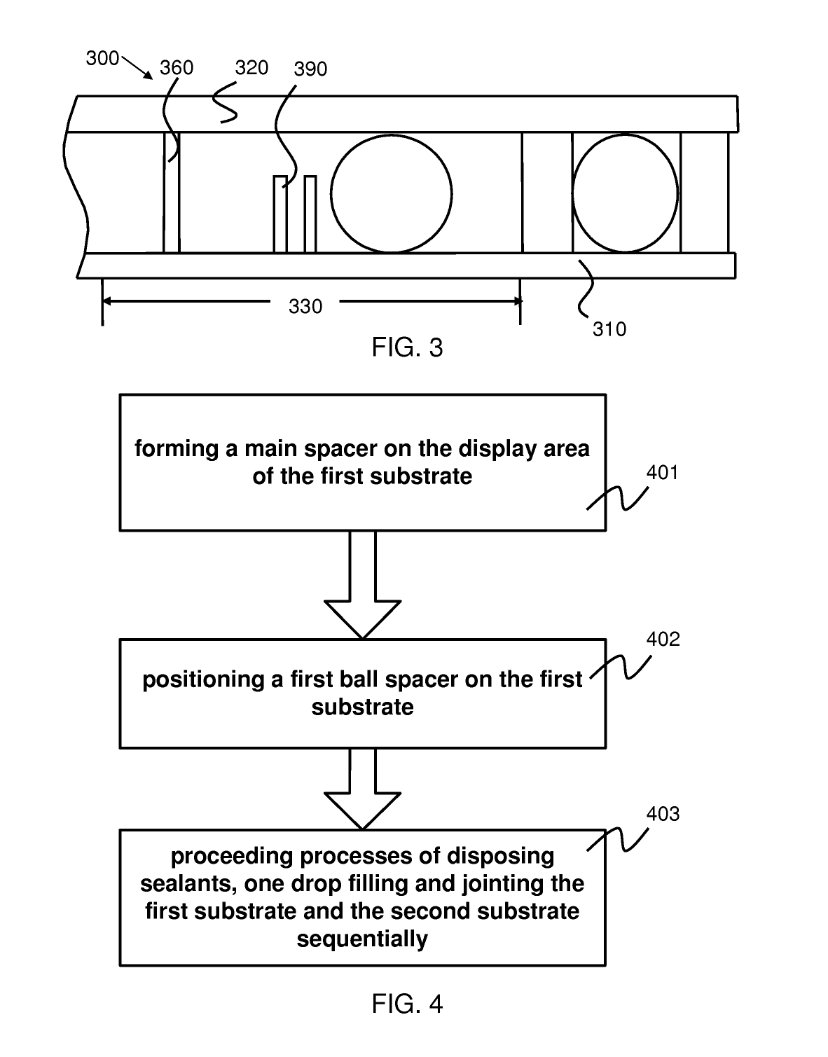

FIG. 3 depicts a structure diagram of a liquid crystal panel according to a third preferable embodiment of the present invention. The liquid crystal panel 300 of this embodiment has similar structure as the liquid crystal panel 200 of the second embodiment. The difference is that: the liquid crystal panel 300 of this embodiment further comprises sub spacers 390 in the display area 330. The sub spacers 390 are employed for reducing the relative movement between the first substrate 310 and the second substrate 320 when the liquid crystal panel 300 is pressed by an external force. The sub spacers 390 can be positioned in the transparent area and/or the opaque area of the first substrate 310. The height of the sub spacer 390 is smaller than that of the main spacer 360. Only the liquid crystal panel 300 suffers an external force and the relative movement between the first substrate 310 and the second substrate 320 occurs, the other end of the sub spacers 390 contact the second substrate 320 for maintaining the gap between the two substrates, and the excessive relative movement between the first substrate 310 and the second substrate 320 does not occur due to the external force. Accordingly, the liquid crystal panel having the sub spacers 390 is capable of reinforcing the support strength between the two substrates thereby as being suffered with the excessive external force to reduce the relative movement between the first substrate 310 and the second substrate 320 due to the external force applied to the second substrate 320.

The present invention also relates to a manufacture method of a liquid crystal panel. Please refer to FIG. 4, which depicts a flowchart of a manufacture method of the liquid crystal panel according to the preferable embodiments. The manufacture method of the liquid crystal panel comprises steps of:

Step 401, providing a first substrate and a second substrate, and the first substrate comprises a display area and a non display area, and forming a main spacer on the display area of the first substrate;

Step 402, positioning a first ball spacer on the first substrate;

Step 403, proceeding processes of disposing sealants, dropping liquid crystal and jointing the first substrate and the second substrate sequentially.

The Step 401 further comprises a step of positioning sub spacers in the display area to reduce the relative movement between the first substrate and the second substrate due to the external force applied to the second substrate.

The Step 402 is to position the first ball spacer in the display area on the first substrate by utilizing an inkjet method.

The Step 403 further comprises disposing a main sealant and a sub sealant in the non display area. The Step 402 further comprises a step of positioning a second ball spacer between the main sealant and the sub sealant.

The manufacture method of the liquid crystal panel according to the present invention positions the main spacer and the first ball spacer on the first substrate at the same time and tremendously reinforces the support strength between the two substrates. In the present invention, the first ball spacer is disposed by inkjet method to reinforce the support strength between the two substrates in advance. Therefore, there is no effect to the main spacer which has already been formed and an extra mask which increases the manufacture cost is not required.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A liquid crystal panel, comprising a first substrate, a second substrate and a liquid crystal layer located between the first substrate and the second substrate, and the first substrate and the second substrate comprises a display area and a non display area around the display area, and a main sealant utilized for sealing the liquid crystal layer is disposed in the non display area, characterized in that,
a main spacer, sub spacers and a first ball spacer are positioned in the display area for maintaining a gap between the first substrate and the second substrate;
the display area comprises a transparent area and an opaque area.

2. The liquid crystal panel according to claim 1, characterized in that a sub sealant is further disposed in the non display area at a periphery of the main sealant.

3. The liquid crystal panel according to claim 2, characterized in that a second ball spacer is positioned between the main sealant and the sub sealant.

4. The liquid crystal panel according to claim 3, characterized in that the second ball spacer is made of opaque material.

5. The liquid crystal panel according to claim 1, characterized in that the main spacer, the sub spacers and the first ball spacer are respectively made of transparent material or opaque material and positioned in the transparent area and the opaque area of the display area correspondingly.

6. A liquid crystal panel, comprising a first substrate, a second substrate and a liquid crystal layer located between the first substrate and the second substrate, and the first substrate and the second substrate comprises a display area and a non display area around the display area, and a main sealant utilized for sealing the liquid crystal layer is disposed in the non display area, characterized in that, a main spacer and a first ball spacer are positioned in the display area for maintaining a gap between the first substrate and the second substrate.

7. The liquid crystal panel according to claim 6, characterized in that a sub sealant is further disposed in the non display area at a periphery of the main sealant.

8. The liquid crystal panel according to claim 7, characterized in that a second ball spacer is positioned between the main sealant and the sub sealant.

9. The liquid crystal panel according to claim 8, characterized in that the second ball spacer is made of opaque material.

10. The liquid crystal panel according to claim 6, characterized in that the display area comprises a transparent area and an opaque area, and the main spacer and the first ball spacer are made of transparent material, and the main spacer and the first ball spacer are positioned in the transparent area.

11. The liquid crystal panel according to claim 6, characterized in that the display area comprises a transparent area and an opaque area, and the main spacer and the first ball spacer are made of opaque material, and the main spacer and the first ball spacer are positioned in the opaque area.

12. The liquid crystal panel according to claim 6, characterized in that the display area comprises a transparent area and an opaque area, and the main spacer is made of transparent material and the first ball spacer is made of opaque material, and the main spacer is positioned in the transparent area and the first ball spacer is positioned in the opaque area.

13. The liquid crystal panel according to claim 6, characterized in that the display area comprises a transparent area and an opaque area, and the main spacer is made of opaque material and the first ball spacer is made of transparent material, and the main spacer is positioned in the opaque area and the first ball spacer is positioned in the transparent area.

14. The liquid crystal panel according to claim 6, characterized in that sub spacers are further positioned in the display area.

15. A manufacture method of a liquid crystal panel, and the liquid crystal panel comprises a first substrate, a second substrate, and the first substrate and the second substrate comprises a display area and a non display area around the display area, the manufacture method of the liquid crystal panel comprising:
A, forming a main spacer on the display area of the first substrate;
B, positioning a first ball spacer on the first substrate;
C, proceeding processes of disposing sealants, dropping liquid crystal and jointing the first substrate and the second substrate sequentially.

16. The manufacture method of the liquid crystal panel according to claim 15, characterized in that the process of disposing sealants is to dispose a main sealant and a sub sealant in the non display area.

17. The manufacture method of the liquid crystal panel according to claim 16, characterized in that the step B further comprises a step of positioning a second ball spacer between the main sealant and the sub sealant by utilizing an inkjet method.

18. The manufacture method of the liquid crystal panel according to claim 15, characterized in that the step A further comprises a step of positioning sub spacers in the display area.

19. The manufacture method of the liquid crystal panel according to claim 15, characterized in that the step B is to position the first ball spacer in the display area on the first substrate by utilizing an inkjet method.
